(19) United States
(12) Patent Application Publication
(10) Pub. No.: US 2009/0095440 A1
(43) Pub. Date: Apr. 16, 2009

(54) METHOD FOR OPTIMISED OPERATION OF AN AIR PREHEATER AND AIR PREHEATER

(76) Inventors: Manfred Gietz, Stuttgart (DE); Volker Schule, Leimen (DE); Berthold Faller, Heidelberg (DE)

Correspondence Address: ALSTOM POWER INC.;INTELLECTUAL PROPERTY LAW DEPT., P.O. BOX 500, WINDSOR, CT, 06095, US

(21) Appl. No.: 12/279,448

(22) PCT Filed: Feb. 23, 2007
(86) PCT No.: PCT/EP07/01599

§ 371 Date: Oct. 13, 2008

(30) Foreign Application Priority Data
Feb. 25, 2006 (DE) 10 2006 008 847.6

(51) Int. Cl. F28D 17/00; G05D 23/00

(52) U.S. Cl. 165/4; 165/287

(57) ABSTRACT

A process is proposed for operating an air preheater (21) with the aid of which heat transfer performance can be raised without condensation appearing on the cold side of the rotor and without a risk of there being deposits on the heating plates.

Regenerative air preheaters have been known of for several decades and have proven themselves in use. The so-termed Ljungström air preheater with a rotor that has one or more layers of heating plates is particularly advantageous. In air preheaters, the air to be heated normally flows, in a housing with at least one air inlet, at least one air outlet, counter to the fumes to be cooled and at least one fumes outlet. The transfer of heat from the fumes to the air occurs by means of the heating plates of the rotor. The invention is not limited to specific designs of regenerative air preheaters, but can, for example, be used successfully in bisector and trisector air preheaters with several air inlets and outlets and also several fumes intakes and outlets.

Naturally, the temperature of the heating plates varies, in otherwise constant operating conditions, with each rotation of the rotor. While hot fumes flow round the heating plates, the temperature does not increase. Following this, the heating plates are flowed over by the cooler air and give off heat into this air. The temperature of the heating plates further sinks in this way.

With this, the temperature behaviour of a given point on the heating plates, shown graphically, is comparable to a saw tooth outline or waved line. The frequency of this waved line depends on the rotational speed of the rotor. The amplitude of the waved line depends on the rotor's rotational speed, the intake temperature and mass flow of the fumes and also the mass flow of the air.

Of course, the characteristics of the heating plates such as the heat transfer coefficient and the heat storage capacity also affect the amplitude of the temperature variations.

The point within the rotor has a substantial effect on the position and amplitude of the waveform temperature variations. The highest heating plate temperature is located at an end of the rotor, also known as the hot side, that of the intake of fumes and outlet of air. The lowest heating plate temperature occurs at the other end, also known as the cold side, that of the outlet of the fumes and the air inlet. Since the greater temperature difference between the air and the fumes occurs on the cold end, the temperature amplitude is at its greatest at that point.

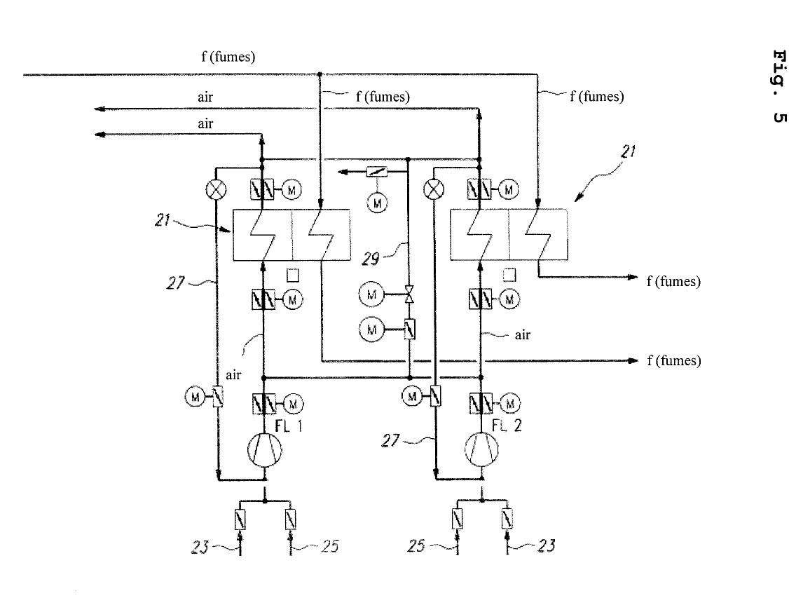

This relationship can be seen from FIG. 4.

In order to prevent condensation or deposition of fumes constituents on the heating plates, an air preheater should be continually operated such that there is no condensation of the fumes at any point on the rotor. This means that the heating plates should at no time, and at no point on the rotor, fall below a minimum temperature Tₘᵢₙ that, among other things, depends on the water, SO₃— and dust content of the fumes.

In order to ensure this, in today's air preheaters, the air intake temperature is frequently raised by means of steam air preheaters or hot air recirculation is raised, more than is strictly necessary, and/or the mass flow of the air through the air preheater is kept lower than is required (with an air bypass channel). With this, the air preheater's capacity is not fully utilized, resulting in a drop in the overall efficiency of the given power unit and hence the economy of the power unit is reduced.

The aim of the invention is to produce a process for operating an air preheater with the aid of which it can, on the one hand, be ensured that the minimum temperature of the heating plates is not fallen below in any operating circumstances or at any point on the rotor, and that simultaneously ensures that maximum possible heat transfer from fumes to air concerned is achieved.

The aim of the invention is achieved by a process for operating a regenerative air preheater, with a rotor, with at least one fumes inlet, with at least one fumes outlet, with at least one air inlet and with at least one air outlet, in which
1. the temperature and
2. the mass flow of the air at the air inlet is determined, and in which
3. the temperature and
4. the mass flow of the fumes at the fumes inlet is determined, and in which
5. the minimum temperature of the heating plates arising for these parameters is determined and controlled such that a set minimum temperature is not fallen below.

Where, in a bisector air preheater for example, an air inlet and a fumes inlet are present, it is enough for a total of two inlet temperatures and two mass flows to be determined.

In this way, it is possible on the one hand to surely prevent corrosion of the heating plates as a result of condensated fume constituents and the deposition of solid fume constituents onto the heating plates, and at the same time to optimize the heat transfer from the fumes to the air.

Since the process in accordance with the invention functions on the basis of the most important parameters, varying operating conditions can also be taken into account with the process in accordance with the invention and the air preheater can consequently be constantly kept at the optimum point of operation.

Since the process in accordance with the invention merely requires knowledge of temperatures and mass flows, which are normally present in any case in the power unit's control means and the control means normally require valves to be present, the costs of carrying out the process are relatively low and very soon pay for themselves with the savings in fuel costs for the power unit.

It is moreover possible to use the process in accordance with the invention in air preheaters that are already in operation, such that, here also, the increases in efficiency of the power unit, in accordance with the invention, can also be realized.

Operation of the air preheater functioning in accordance with the invention can be further improved by determining the temperature of the fumes at the fumes outlet and of the air at the air outlet, and these parameters are likewise taken into account in determining the minimal temperatures of the heating plates.

In the case of rotors with several layers of heating plates, the minimum temperature of the heating plates is favourably determined at the point of transition from one layer of heating plates to another, since there also there may be localized minimum temperatures of the heating plates.

The minimum temperature of the heating plates can be determined during operation by measuring the actual temperatures arising on the given heating plate. Here it is particularly favourable if these temperatures are determined by measurements made under different operating conditions and these temperature measurements are entered into a performance graph. On the basis of the measured temperatures filed in the performance graph, a control device can determine the actual minimum temperatures of the heating plate and control operation of the air preheater accordingly, with the aid of the given current values of the temperatures and mass flows of the fumes and of the air, by reading off the temperatures set in the performance graph. In this way it is possible on the one hand to carry out the control of air preheaters on the basis of the actually measured values. Additionally, no measuring technology needs to be on the rotor during the operation of the air preheater. In this way, the process can be very safe, economic and yet accurate.

Alternatively it is also possible to determine the minimum temperature of the heating plates with the aid of a calculation model, by means of a finite elements calculation of the temperatures in the air preheater, particularly though on the rotor heating plates, for example. Here also, it is possible for the minimum temperatures at different operating conditions to be calculated, and for the temperatures calculated in this way to be set down in a performance graph. As explained above, the temperatures stored in the performance graph or characteristic map can be used to control the temperature and/or the mass flow of the air in the air inlet. Alternatively, of course, an FEM calculation can be redone with every change in operating conditions, and the air preheater be controlled in accordance with the calculation results.

It has proven effective and advantageous to raise the air inlet temperature by preheating by means of steam air preheaters or by leading back already heated air from the air outlet to the air inlet, where there is a need to do this. It is moreover favourable if, where necessary, a partial flow of the air to be preheated is skirted past the air preheater in the bypass channel. Both leads to the minimum temperatures on the heating plates rising and consequently the critical minimum temperature is not fallen below. Since these measures can be carried out very easily and the necessary construction of apparatus is easily comprehensible, these measures are particularly suited to controlling an air preheater operated in accordance with the process of the invention.

The aim that is the basis of the present invention is solved by means of a device for controlling an air preheater through its being suited to carrying out the process in accordance with one of the above claims. The same applies to a computer program that is suited to carrying out the said process.

The initially stated aim is likewise solved, by an air preheater with devices for determining the temperature and mass flow of the air at the air inlet and also the temperature and mass flow of the fumes at the fumes inlet, by giving the air preheater a control device operating in accordance with claims 1 to 13.

In an improved variant design of the air preheater in accordance with the invention, the said preheater has devices for determining the temperature and/or the mass flow of the air at the air outlet and/or for making recordings at the fumes outlet.

Further advantages and favourable designs of the invention can be deduced from the attached diagrams, the descriptions of these and from the patent claims. All characteristics shown in the annexed diagrams, or described or mentioned in the description section or the claims can be essential to the invention both separately or in any combination.

The annexed diagrams are as follows:

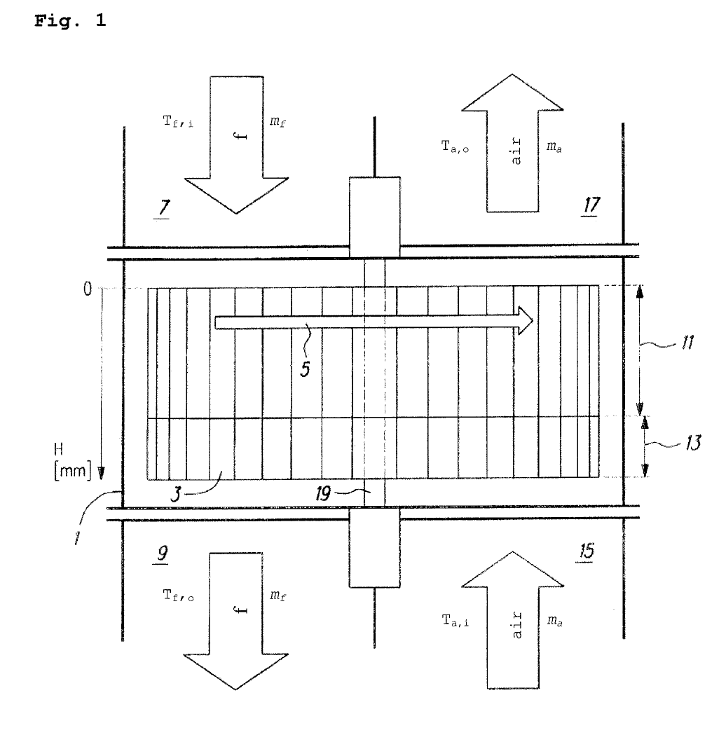

FIG. 1 a diagrammatic representation of a sectional view through a regenerative air preheater,

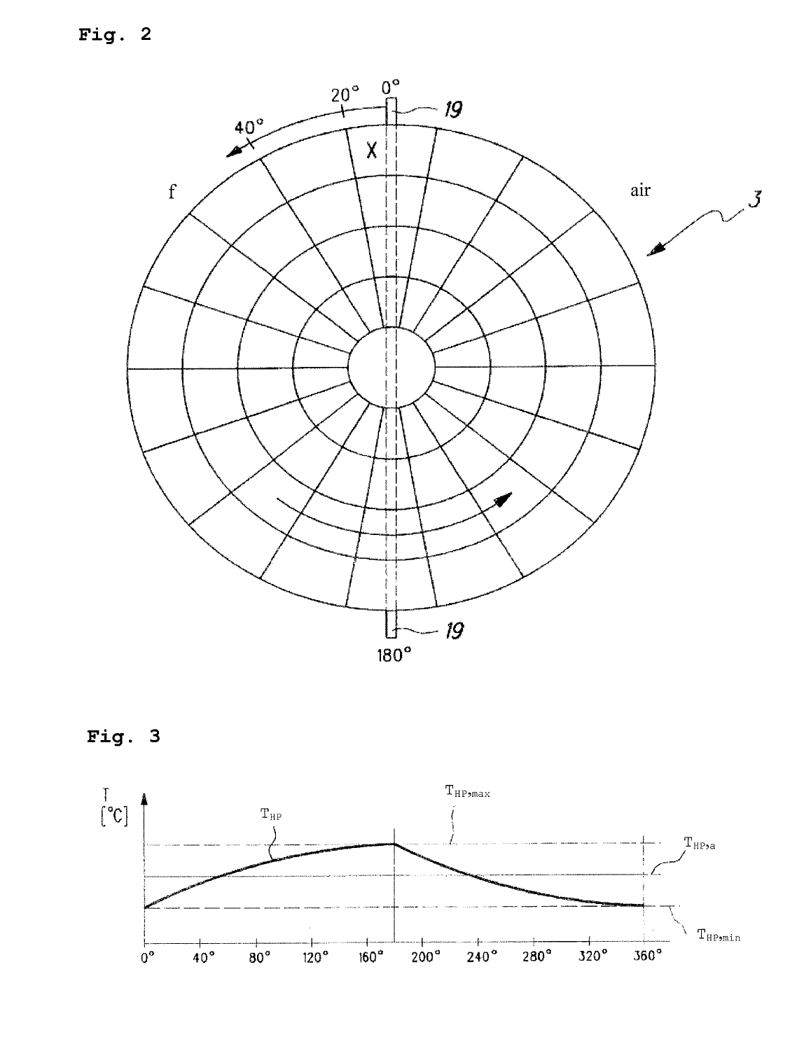

FIG. 2 a plan view of a rotor of a regenerative air preheater,

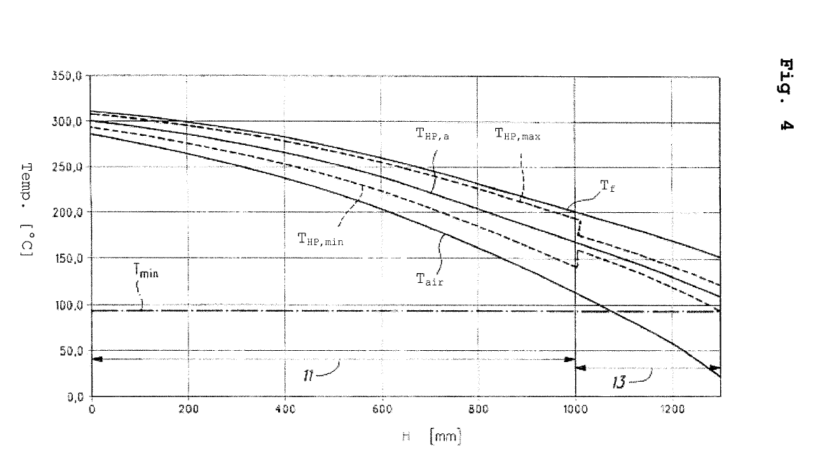

FIG. 3 the temperature behaviour, with time, of a heating plate,

FIG. 4 the most important temperatures, during operation of the air preheater, in relation to the height of the heating blades of the rotor, and

FIG. 5 a circuit diagram of two regenerative air preheaters, with hot air return feed and a cold air bypass channel, operating on the basis of the process in accordance with the invention.

### DESCRIPTION OF THE DESIGN EXAMPLES

FIG. 1 shows a lateral view of a regenerative air preheater, with a housing 1 shown sectioned. A rotor 3 is supported in the housing 1 such that it can rotate. The rotor 3 can be set in rotation by means of a drive that is not shown. The rotor's 3 rotation is indicated, in FIG. 1, by an arrow 5.

Fumes (f) flow, in the direction of the arrows, through the left half of the housing 1. The fumes enter the air preheater at an air inlet 7 and leave the air preheater by a fumes outlet 9. On the way from the fumes inlet 7 to the fumes outlet 9, the fumes flow through the section of the rotor 3 that is located in the left section of the housing 1.

In the design shown in FIG. 1, the rotor 3 has two layers of heating plates. The so termed hot layer 11 is disposed in the upper part of the rotor 3. The layer 13, known as the cold layer, is located in the section lying below it.

The hot layer 11 and the cold layer 13 differ with regard to their material, their surface coating and geometry and are optimally adjusted to the conditions existing at the time.

An air inlet 15 and an air outlet 17 are disposed on the right-hand side of the air preheater as shown in FIG. 1. The direction of flow of the air that enters the air preheater by the air inlet 15 and leaves it by the air outlet 17 runs counter to the direction of flow of the fumes.

When the fumes flow through the rotor 3 section, in the left-hand section of FIG. 1, they give off heat to the heating plates of the rotor 3 and heat the heating plates' hot layer 11 and cold layer 13. The fumes cool simultaneously. This means that an inlet temperature T_{f} of the fumes at the fumes inlet 7 is higher than an outlet temperature T_{f} of the fumes at the fumes outlet 9.

If the heating plates, heated in this way, move, through rotation of the rotor, from what is the left-hand section of the air preheater in FIG. 1 to the right-hand section, then they heat the cold air and themselves cool down. This means that an inlet temperature T_{a,i} of the air at the air inlet 15 is lower than an outlet temperature T_{a,o} of the air at the air outlet 17.

As a result, part of the detectable heat in the fumes is transferred, with the aid of the air preheater, to the air.

In order to prevent mixing of air and fumes, there are axial and radial sealing plates 19 between the left-hand and right-hand sections of the housing 1.

FIG. 2 shows a plan view of the rotor 3 of FIG. 1, diagrammatically showing the radial sealing plates 19. This plan view shows that the rotor 3 comprises different sectors with partitions (tangential faces) (not carrying a reference number). In these segments, the heating plates are packed into containers (not shown). If, for example, the heating plate marked ‘X’ now turns into the left-hand section of the air preheater, starting from the radial seal, it is then flowed round and heated by the flow of fumes that is present there. This process continues as far as the end of the gas sector. Then, the selfsame segment X leaves the left-hand section of the air preheater, turns through and below the seal 19 and enters the right-hand section of the air preheater. There, the heating plate that is now heated has the cool air flowing round it and thereby gives of heat to the air. This process continues until the end of the air sector is reached.

In FIG. 3, the temperature behaviour is qualitatively applied to a point on the heating plate over the rotors angle of rotation. At an angle of rotation of approx. 180°, the heating plate leaves the section that is flowed through by the fumes and enters the section of the air preheater that is flowed through by cooler air.

The temperature of the heating plate is marked T_{HP} in FIG. 3. As can be seen from FIG. 3, the temperature T_{HP} of the heating plate changes up and down between two temperature limits, namely a maximum temperature T_{HP, max} and a minimum temperature T_{HP, min}. The average value of the temperature T_{HP} of the heating plate, with time, is marked T_{HP, a} in FIG. 3.

The heating plate reaches the maximum temperature T_{HP, max} at an angle of rotation of approx. 180°, while it reaches its minimum temperature at an angle of rotation of approx. 0° or 360°.

Obviously, the actual values of the maximum temperature T_{HP, max} and the temperature T_{HP, min} depend, among other things, on layout and the point of operation of the air preheater. Hence, the following parameters, for example, are of importance to the temperature T_{HP} of the heating plate: The mass flow m_{f} and the temperature T_{f} of the fumes at the fumes inlet 7 and the inlet temperature T_{a,i} and the mass flow mₐᵢᵣ of the air at the air inlet 15. In particular, the minimum temperature of the heating elements T_{HP, min} can be raised by changing one of the above quantities.

In order to prevent soiling of the air preheater and the resulting loss of pressure, and also a resulting failure of the power unit block, an air preheater has to be operated such that, on the fumes side, a minimum temperature Tₘᵢₙ of the heating elements, particularly on the cold layer of the heating plates, is not fallen below for a long time-period.

The minimum temperature Tₘᵢₙ is determined through, among other things, the composition of the fumes. Here, the water, SO₃— and dust content, and also the ash composition, here especially the Ca- and Mg-content, are of particular importance. If the composition of the fumes is known, then the minimum temperature Tₘᵢₙ can be calculated.

In order to ensure safe operation of the air preheater in spite of variations in quantities having an influence, such as the inlet temperature of the fumes T_{f}, the mass flow m_{f} of the fumes, the air inlet temperature T_{a,i} and the mass flow mₐ of the air, the air preheater is normally operated such that the minimum temperature T_{HP, min} of the heating plate is higher than the above-mentioned minimum temperature at which the fumes condense or solid constituents of the fumes adhere to the heating plates.

The larger the ‘safety gap’ between the actual minimum temperature T_{HP, min} occurring on the heating plate and the minimum temperature Tₘᵢₙ, the more heat goes lost, unused, in the fumes. This leads to a reduction in efficiency of the power unit block and thereby to increased emissions and fuel costs.

FIG. 4 shows essential and characteristic temperatures plotted in relation to heating plate height H, as occurs while the air preheater is in operation.

The heating plate height H is also shown diagrammatically in FIG. 1. It starts at the upper rim of the rotor 3, where the hot fumes first enter onto the rotor 3.

In FIG. 4, heating plate height is plotted on the X-axis, and, as for the rotor in accordance with FIG. 1, is divided up into a hot 11 and a cold 13 layer. The uppermost line in accordance with FIG. 4 is the fumes temperature T_{f}, while the lowest temperature is that of the air Tₐᵢᵣ. Both the fumes temperature T_{f} and the air temperature Tₐ can of course change with flow through the rotor 3. The heating plate temperatures lie between the upper limit T_{f} and the lower limit Tₐᵢᵣ. This can be seen from the middle heating plate temperature T_{HP} in FIG. 4.

FIG. 4 also shows the maximum temperatures T_{HP, max} and the minimum temperatures T_{HP,min} of the heating plates. During operation, the actual temperature of a rotor 3 heating plate moves up and down.

A minimum temperature Tₘᵢₙ that, for example, is a little less than approx. 100° C., is entered in FIG. 4. No part of the rotor 3 must fall below this temperature at any time. Higher temperatures are not critical and do not therefore require any particular attention.

The behaviour of the minimum temperature T_{HP,min} of the heating plates is particularly important to problem-free operation of the air preheater. Starting with a height on the heating plates H=0 mm, the temperature T_{HP,min} lies at almost 300° C. and is thereby markedly higher than the minimum temperature Tₘᵢₙ. The temperature T_{HP,min} falls with increasing height on the given heating plate. There is a non-uniformity at the point of transition from the hot layer 11 to the cold layer 13, resulting from the changed heat transfer qualities of the two layers 11 and 13.

Since the heat storage capacity of the cold layer 13 is higher than that of the hot layer 11, the minimum temperature Tₘᵢₙ climbs at the point of transition to the hot layer 11 from the cold layer 13 again and then falls again. The temperatures T_{HP,min} and Tₘᵢₙ intersect at H=1.250 mm, that is, at the lower end of the rotor 3 in FIG. 1. This means that the air preheater is optimally operated. On the one hand, as much heat as is possible is transferred from the fumes to the air and, at the same time, the temperature at no point at any time falls below the minimum temperature Tₘᵢₙ of the heating plates.

Both the behaviour of the temperatures T_{HP,max} and T_{HP, min.} and also the minimum temperature Tₘᵢₙ depend on the operating conditions of the air preheater.

The actual temperatures on the heating plates, particularly the minimum temperature T_{HP, min.} can be determined on the basis of the place, and the operating parameters T_{f}, m_{f}, Tₐᵢᵣ and mₐᵢᵣ on the basis of heating plate temperature measurements in the area of the maximum heating plate height H and at each point of transition from one layer 11 to another layer 13 for example. This process is nevertheless not suited to long-term operation, since the high temperatures arising there and the ash content of the fumes and their corrosive constituents greatly limit the useful life of such measuring technique.

It is therefore provided for in accordance with the invention that the temperature of the heating plates be periodically determined at specific points, with the aid of a calculation model of the air preheater. The most measured process parameters m_{f}, T_{f,i}, mₐᵢᵣ and Tₐᵢᵣ are used as input variables for the calculation model.

Depending on the results of the calculation model, the air preheater is then operated such that the temperature T_{HP} of the heating plates always lies above the minimum temperature Tₘᵢₙ. For example, the air preheater can be operated such that a constant separation of, for example 50 Kelvin from the minimum temperature Tₘᵢₙ is maintained.

One or more of the following parameters can be used to control the air preheater: the proportion of internal air sucked up to the external air sucked up can be varied. The temperature T_{air,i} at the air inlet 15 increases as a result of an increase in the proportion of internal air.

It is moreover possible to increase the air inlet temperature by connecting in a steam air preheater, fed with steam, before the air preheater.

The temperature Tₐᵢᵣ at the air inlet 15 can moreover be increased by returning part of the already preheated air from the air outlet 17 back to the air inlet 15 (hot air return feed).

Part of the air at the air inlet can furthermore be divided off and go past the air preheater in the bypass channel (‘air bypass’).

FIG. 5 shows a block diagram of two air preheaters 21 functioning on the basis of the process in accordance with the invention. Since standard symbols have been used in the block diagram, these and the components used are not further described here. Only the most important sub-assemblies and circuits, that are of particular significance to the invention are explained below.

The air preheaters 21 are supplied with fumes f from a boiler that is not shown. Having left the air preheater 21, the fumes f go into the fumes purification unit (not shown).

Air flows through the air preheaters 21 in a direction running counter to that of the flow of fumes f. The air preheated by the air preheater 21 is then supplied to the boiler that is not shown or is used to dry coal or other carbonaceous material.

The air supplied to the air preheaters 21 can come from an external air suction means 23 or an internal air suction means 25, with which air is sucked from the boilerhouse.

Since the internal and external air are at different temperatures, the temperature of the air at the inlet to the air preheater 21 can, within limits, be controlled through selection of the mixing ratio of internal to external air.

A further possibility for raising the air temperature at the air inlet of the air preheater 21 is for a part of the preheated air to be shunted off to the air outlet 17 and be fed back into the air inlet 15. The conduit for this is characterized as a hot air return means 27. A further possible way to influence the parameters of operation of the air preheater 21 is to shunt off part of the air before the air inlet 15 and to direct is past the air preheaters 21 in the bypass channel. This bypass channel is marked 29 in FIG. 5.

FIG. 5 shows that there are a number of possible ways of raising the air inlet temperature T_{air,i} and to reduce the mass flow mₐᵢᵣ through the air preheater 21. Therefore, it is always possible to operate the air preheater 21 such that, on the one hand, maximum heat transfer is achieved and, secondly, such that the temperature T_{HP} of the heating plates does not fall below the minimum temperature Tₘᵢₙ.

Approximation formula for determining the average heating plate temperature T_{HP-KSm} on the cold side of the air preheater:

T_{HP-KSm}=(T_{air,i}+f×(T_{f,i}+ΔT_{Le}))/(1+f)

where

T_{air,i}=37° C.

T_{f,o}=184° C.

F=fα×fg

with f: factor of heat transfer and division of the gas and air side of the air preheater

### EXAMPLE

taking the following values as a basis for the calculation:

### ΔT_{Le}=8 k

fα=1.37
fg=1.44
f=1.97
gives the minimum heating plate temperature on the cold side as follows:

$$\begin{matrix}{T}_{HP \text{-} KSm} = ( {T}_{air , I} + 1.97 \times ( {T}_{f , i} + 8 k ) / ( 2.97 ) \\ = 140 ° C .\end{matrix}$$

1-15. (canceled)

16. A process for operating a regenerative air preheater having a rotor with a plurality of heating plates disposed thereon, at least one fumes inlet to the rotor, at least one fumes outlet from the rotor, at least one air inlet to the rotor, and at least one air outlet from the rotor, the process comprising:
determining a temperature of air (T_{air, i}) at the at least one air inlet;
determining a temperature of fumes (T_{F, i}) at the at least one fumes inlet;
determining at least one of: a mass flow of the fumes (m_{F}) at the at least one fumes inlet, and a mass flow of the air (mₐᵢᵣ) at the at least one air inlet;
determining a minimum temperature of the heating plates (T_{HP, min}) using T_{air, i}, T_{F, i}, and the at least one of mₐᵢᵣ, and m_{F}; and
controlling at least one of T_{air, i}, T_{F, i}, mₐᵢᵣ, and m_{F} so that T_{HP, min.} does not fall below a predetermined minimum temperature (T_{min.}).

17. The process of claim 16, wherein determining T_{HP, min} includes:
calculating an average heating plate temperature on the cold side of the air preheater (T_{HP-CSa}).

18. The process of claim 17, wherein T_{HP-CSa} is calculated according to the formula:
T_{HP-CSa}=(T_{air,i}+f×(T_{f,i}+ΔT_{Le}))/(1+f)
wherein f is a factor for heat transmission and allotting the gas side and the air side of the air preheater; and ΔT is a temperature difference.

19. The process of claim 16, wherein T_{HP, min} is determined using a heating plate temperature (T_{HP}) measured at least one of: a point on the heating plates and a space between the heating plates.

20. The process of claim 19, wherein T_{HP} is recorded for different operating conditions of the regenerative air preheater and T_{HP, min} is determined using the recorded T_{HP} values.

21. The process of claim 20, wherein the T_{HP} values are recorded in a performance graph or characteristics map.

22. The process of claim 21, wherein the performance graph or characteristics map is used in controlling the at least one of T_{air, i}, T_{F, i}, mₐᵢᵣ, and m_{F} so that T_{HP, min.} does not fall below T_{min.}.

23. The process of claim 16, wherein T_{HP, min} is determined using a calculation model, by calculating a temperature (T_{HP}) present on the heating plate.

24. The process of claim 16, wherein T_{HP, min} is determined using at least one of: the water content of the fumes, the dust content of the fumes, the SO₃ concentration of the fumes, and the composition of the ash contained in the fumes.

25. The process of claim 16, wherein controlling at least one of T_{air, i}, T_{F, i}, mₐᵢᵣ, and m_{F} includes:
increasing Tₐᵢᵣ by feeding back air from the air outlet to the air inlet.

26. The process of claim 16, wherein controlling at least one of T_{air, i}, T_{F, i}, mₐᵢᵣ and m_{F} includes:
decreasing mₐᵢᵣ by bypassing air around the rotor.

27. The process of claim 16, wherein determining T_{air, i} and determining T_{F, i} includes:
measuring T_{air, i} and T_{F, i}.

28. The process of claim 16, wherein determining mₐᵢᵣ and determining m_{F} includes:
measuring mₐᵢᵣ and m_{F}.

29. A regenerative air preheater comprising:
a rotor having a plurality of heating plates;
at least one fumes inlet to the rotor and at least one fumes outlet from the rotor, fumes at the fumes inlet having a temperature T_{F, i} and a mass flow m_{F};
at least one air inlet to the rotor and at least one air outlet from the rotor, air at the air inlet having a temperature T_{air, i} and a mass flow mₐᵢᵣ; and
a controller configured to:
determine a minimum temperature of the heating plates (T_{HP, min}) using T_{air, i}, T_{F, i}, and at least one of mₐᵢᵣ, and m_{F}, and
control at least one of T_{air, i}, T_{F, i}, mₐᵢᵣ, and m_{F} so that T_{HP, min.} does not fall below a predetermined minimum temperature (T_{min.}).

30. The regenerative air preheater of claim 29, wherein the processor determines T_{HP,min} using a calculated average heating plate temperature on the cold side of the air preheater (T_{HP-CSa}).

31. The regenerative air preheater of claim 30, wherein the processor determines T_{HP-CSa} using the formula:
T_{HP-CSa}=(T_{air,i}+f×(T_{f,i}+ΔT_{Le}))/(1+f)
wherein:
f is a factor for heat transmission and allotting the gas side and the air side of the air preheater; and ΔT is a temperature difference.

32. The regenerative air preheater of claim 29, wherein the processor determines T_{HP, min} using temperatures of the heating plates (T_{HP}) recorded for different operating conditions of the rotary regenerative air preheater.

33. The regenerative air preheater of claim 32, wherein the T_{HP} values are recorded in a performance graph or characteristics map stored in the processor.

34. The regenerative air preheater of claim 29, wherein the processor calculates T_{HP, min} using a calculation model.

35. The regenerative air preheater of claim 29, wherein the processor calculates T_{HP, min} using at least one of: the water content of the fumes, the dust content of the fumes, the SO₃ concentration of the fumes, and the composition of the ash contained in the fumes.

36. The regenerative air preheater of claim 29, further comprising:
a hot air return line extending from the air outlet to the air inlet; and wherein
the processor adjusts an amount of air flowing from the air outlet to the air inlet through the hot air return line to control Tₐᵢᵣ.

37. The regenerative air preheater of claim 29, further comprising:
a cold air bypass line extending from the air inlet to the air outlet; and wherein
the processor adjusts an amount of cold air flowing from the air inlet to the air outlet through the cold air bypass line to control mₐᵢᵣ.
